(19) United States
(12) Patent Application Publication
(10) Pub. No.: US 2015/0381722 A1
(43) Pub. Date: Dec. 31, 2015

(54) SYSTEM AND METHOD FOR MANAGING INTERACTIVE CONTENT

(71) Applicant: AMDON CONSULTING PTE LTD, Singapore (SG)

(72) Inventors: Yew Khuen Eric Lam, SG (SG); Mark Walter Salata, San Diego, CA (US); Naing Aye Nay, SG (SG)

(21) Appl. No.: 14/768,160

(22) PCT Filed: Dec. 27, 2013
(86) PCT No.: PCT/SG2013/000557

§ 371 Date: Aug. 14, 2015

(51) Int. Cl. H04L 29/08; G06F 3/0484; G06F 3/0483; H04L 29/06

(52) U.S. Cl. CPC H04L 67/1095; H04L 65/403; G06F 3/04842; G06F 3/0483

(57) ABSTRACT

A system and method for managing a workbook in a learning environment where a first user receives a book in electronic form, completes the activity embedded in the book and submits the activity to a second user via a server. The second user can then provide feedback regarding the activity to the first user and all inputs can be done without requiring an internet connection.

### CROSS-REFERENCES TO RELATED APPLICATIONS

This application is a U.S. National Phase Application under 35 U.S.C. §371 of International Application No. PCT/SG2013/000557, filed Dec. 27, 2013, the entire contents of which are hereby incorporated herein by reference.

### FIELD OF THE INVENTION

The present invention relates to a system and method for managing interactive content, such as but not limited to a workbook in an e-learning environment.

### BACKGROUND

Horizon Report 2011 placed the time-to-adoption for mobile devices such as smartphones and tablets to be one year or less, noting that in developed countries, one could expect practically all students in the upper grades to carry a mobile device. K-12 schools are also increasingly seeing the potential of mobile devices and noting that not only are the devices themselves less expensive than most laptops, they need less infrastructure to support them. On the other hand, personal computer (PC) penetration in Singapore households with at least one schooling child is as high as 100%, due largely to highly successful schemes in Singapore schools. Schools in Singapore and abroad have therefore been looking at ways to leverage on this trend of rapid adoption of mobile devices to offer learning experiences that are engaging and promote deeper levels of understanding in their students. Presently, learning management systems in schools seem to have been deployed to leverage on the trend of rapid adoption of mobile devices, but anecdotal evidence suggests that the adoption by educators and students has not been entirely encouraging.

The desire to leverage on this trend is due to a proliferation of computer devices that are portable, although not necessarily connected to the Internet perpetually. The fact that computers in the form of tablets and smartphones are more portable than ever raises the possibility of having richer content that can now come to life as compared to the flat representations in printed and even some digital textbooks yet remaining extremely light (in the form of the weight of the tablet or smartphone).

The answer proposed by many content providers has been to offer content that is accessible online and so negates the requirement for device-specific access—but this has its limitations: to access the content the devices need to be connected into the Internet and the bandwidth must be sufficient to allow for seamless consumption of richer content such as videos which are large in size and often tend to be highly engaging to students in the first 10 years of their formal education.

As a result, educators seek solutions that must first allow offline access to greater content, and offer the opportunity for online interactions, where available.

Student-centered learning has been the aim for many educators, with the emphasis on engaging students and helping them understand concepts rather than the traditional focus on rote learning and recalling of information in examinations. These are bold aims that challenge teachers to transform their method of teaching, monitoring, assessing and grading of their students. For many teachers, this involves too many changes with too big a risk to take as they are of the view that the current methods of assessing understanding through examinations have not really caught up.

The general sense of many educators has therefore been to take tentative steps towards this grandiose goal, starting perhaps with content that engages and are relevant to the learner, and supported by a system that allows them to check regularly if their learners have understood a concept or have been on task without necessarily inhibiting his/her learning experience.

The call for assessment for learning or formative assessment echoes the desire to first help learners understand and therefore learn. Authors like Paul Black et. al (2003) outlined several key elements of formative assessment with the ability to provide feedback by marking and effective questioning as some of the more doable tasks for teachers in the short term. Feedback by marking essentially involves the teacher providing a feedback/comment on the students' works rather than a final mark.

But this process demands a continuous ‘back-and-forth’ interaction between the teacher and student, albeit not in real time. The state of learning resources today means that a teacher would need to constantly collect students' workbooks, provide feedback, return the books to the students, re-collect the students' books to review their comments, and repeat the process as necessary. Each time a student submits his/her book to the teacher, that resource is not available for the student to refer to, making the learning process discontinuous.

Existing online-based learning management systems (LMS) were thought to address the issues surrounding this interaction. However, conversations with teachers and LMS providers in Singapore and Hong Kong have shown that many teachers have been less than lukewarm in adopting the LMS as part of their regular teaching practice.

A possible scenario showcasing the current state of the LMS is as follows: In trying to review a students' work through a LMS, a stable internet is required on a device, and after logging in, the teacher then locates the student, followed by the subject and thereafter the particular assignment that was tasked. Aside from requiring a constant stable internet connection, this is a tedious process just to access a students' work, let alone reviewing and marking the work itself. If this is multiplied by the number of students in a number of classes, it would take a long time in order to access the work to be reviewed and assessed.

Broadband infrastructure worldwide is unable to catch up with the incredibly rich content that accompanies the ability of computing devices to consume them. And in the end, many teachers contend with having the LMS around to perform very rudimentary functions. Interactions between students and teachers have therefore not changed significantly and the LMS is still far from achieving what it has been conceived to be schools, even as they are practically present in all K-12 schools in Singapore and Hong Kong.

While the democratization of knowledge is an on-going trend, learner-driven methods of learning are unlikely to take center-stage in the foreseeable future for obvious reasons eg., current modes of universally recognized assessment, the community's view on non-authority-based learning, etc. Because of this, the teacher will still play a central role in the learning of students and the teacher will continue to drive and determine how learners learn, when they learn, and what they should learn.

This means that any system that is to be developed must take into consideration the educator's role in the education value chain so that learning is relevant, useful and applicable.

Having an LMS that flags out to learners whenever a teacher comes on line does not sit well with a teacher, who seeks to have his/her privacy respected. This is especially so when real-time interactions between teacher and student are already made available in the regular classroom lessons and any after-school remedial programs.

Thus, the teacher would still want to be able to access the works of his/her students but would want to have the privacy to review them whenever possible or convenient.

Such a system demands that information be synchronized regularly between works that are accessed from different devices with a deliberate aim to omit any real-time communication functionalities.

The present invention provides a system that seeks to meet the need of an educator to access the works of student(s) but would wish to have the flexibilibity or privacy to review the work, at least in part.

### SUMMARY

Throughout this document, unless otherwise indicated to the contrary, the terms “comprising”, “consisting of”, and the like, are to be construed as non-exhaustive, or in other words, as meaning “including, but not limited to”.

A first advantage of the system in accordance with this invention is that teachers are able to teach more efficiently and increase their productivity by being able to gain access to workbooks quickly. This ensures that teachers gain feedback quickly on how well the students are learning. A second advantage of the system in accordance with this invention is that the system is operate system independent and can operate between various devices, without requiring internet or web. This ensures that both teachers and students are able to use the workbook easily and freely. A third advantage of the system in accordance with this invention is that it allows for submission of inputs from students and feedback from teachers in a digital workbook form. This ensures that feedback is captured quickly and transmitted effectively between teachers and students. A fourth advantage of the system in accordance with this invention is that the teacher is able to customize the contents of the workbook. This ensures that students are learning at the right pace. A fifth advantage of the system in accordance with this invention is that it follows the current workflow of teachers. This ensures that the invention augments the current workflow and provides an interactive and portable environment for anytime, anywhere access on all computing devices.

In accordance with a first aspect of the invention there is a system for managing interactive content comprising a first computing device configured to receive interactive content comprising at least one activity, the at least one activity requires the submission of an input of a first user; a second computing device configured to allow a second user to submit a comment on the input of the first user; and a server arranged to receive the input or comment of either the first or second computing device where a data connection is present; wherein the first and second computing devices are configured to detect the presence of data connection with the server and upon detection of the presence of data connection with the server; prompt the first or second user to synchronize:
i. any activity within the interactive content on the server that the first and second computing devices have permission to access respectively; and
ii. any activity within the interactive content input or comment by the first or second user respectively, where the input of the first user is added to the activity of the interactive content and the interactive content is an electronic book.

In accordance with a second aspect of the invention there is a system for managing interactive content comprising a first computing device configured to receive interactive content comprising at least one activity, the at least one activity requires the submission of an input of a first user; a second computing device configured to allow a second user to submit a comment on the input of the first user; and a server arranged to receive the input or comment of either the first or second computing device where a data connection is present; wherein the server is configured to detect the presence of data connection with the first or second computing device and upon detection of the presence of data connection with the first or second computing device, synchronize:
i. any activity within the interactive content on the server that the first or second computing devices have permission to access respectively and;
ii. any activity within the interactive content input or comment by the first or second user respectively, where the input of the first user is added to the activity of the interactive content and the interactive content is an electronic book.

Preferably the comment of the second user is added to the activity where the input of the first user was added to the interactive content.

Preferably the system is a learning management system and the first user is a student and the second user is a teacher or instructor.

Preferably the activity is dynamically embedded in the electronic book.

Preferably the system further comprises a secure token operable to be used by the first user or the second user to register with the server.

Preferably the registration further comprises security verification via a unique identifier and password for the first and second user.

Preferably the server sends a notification to the first computing device when comment to the at least one activity is received by the server.

Preferably the first computing device is operable to receive a further input from the first user in response to the comment to the at least one activity.

Preferably the server merges multiple versions of the inputs when the first user submits multiple versions of the inputs by using all versions of the inputs in relation to the activity.

Preferably the server merges multiple versions of the inputs when the first user submits multiple versions of the input by the first user by discarding an earlier version of the input.

Preferably the server merges multiple versions of the inputs when the first user submits multiple versions of the input by discarding the version of the same input with a smaller file size.

Preferably the second computing device is configured to receive a score which accompanies the comment by the second user.

Preferably the server is operable, when a data connection is present, to receive instruction from the second computing device to combine one or more interactive content on the server.

Preferably the first computing device is configured to receive text, drawings, graphs, photographs or combinations of one or more of the above as inputs.

Preferably the second computing device is configured to receive text, drawings, graphs, photographs or combinations of one or more of the above as comments.

In accordance with a third aspect of the invention there is a method for managing interactive content comprising the following steps: receiving at a first computing device interactive content comprising at least one activity, the at least one activity requiring the submission of an input of a first user; submitting to a server at least one activity with the input of the first user; receiving at a second computing device at least one activity with the input of the first user; creating a comment by a second user in response to the at least one activity with the comment of the second user; wherein the server is arranged to receive the input/comment of either the first or second computing device when a data connection is present, the first and second computing devices further configured to detect the presence of data connection with the server and upon detection of the presence of data connection with the server; prompt the first or second user to synchronize:
i. any activity within the interactive content on the server that the first and second computing devices have permission to access respectively and
ii. any activity within the interactive content input or commented by the first or second user respectively, where the input of the first user is added to the activity of the interactive content and the interactive content is an electronic book.

In accordance with a fourth aspect of the invention there is a method for managing interactive content comprising the following steps: receiving at a first computing device interactive content comprising at least one activity, the at least one activity requiring an input of a first user; submitting to a server (receiving at a server) at least one activity with the input of the first user; receiving at a second computing device at least one activity with the input of the first user; creating a comment by a second user in response to the at least one activity; and submitting to the server at least one activity with the comment by the second user; wherein the server is configured to detect the presence of data connection with the first or second computing device and upon detection of the presence of data connection with the first or second computing device, synchronize
i. any activity within the interactive content on the server that the first or second computing devices have permission to access respectively and;
ii. any activity within the interactive content input or comment by the first or second user respectively, where the input of the first user is added to the activity of the interactive content and the interactive content is an electronic book.

Preferably the comment of the second user is added to the activity where the input of the first user was added to the interactive content.

Preferably the method is adapted for use in a learning management system where the first user is a student and the second user is a teacher or instructor.

Preferably the activity is dynamically embedded in the electronic book.

Preferably the method further comprises a step to authenticate the first user or the second user for access to the interactive content or uploading any input/commented activity.

Preferably the step to authenticate further comprises security verification via a unique identifier and password for the first and second user.

Preferably the server sends a notification to the first computing device when comment to the at least one activity is received by the server.

Preferably the first computing device receives a further input from the first user in response to the comment to the at least one activity.

Preferably the server is arranged to merge multiple versions of the inputs when the first user submits multiple versions of the input by using all versions of the inputs in relation to the activity.

Preferably the server merges multiple versions of the inputs when the first user submits multiple versions of the input by the first user by discarding an earlier version of the input.

Preferably the server merges multiple versions of the inputs when the first user submits multiple versions of the input by discarding the version of the same input with a smaller file size.

Preferably the second computing device is configured to receive a score which accompanies the comment by the second user.

Preferably the server is operable, when a data connection is present, to receive instruction from the second computing device to combine one or more interactive content on the server.

Preferably the first computing device is configured to receive text, drawings, graphs, photographs or combinations of one or more of the above as inputs.

Preferably the second computing device is configured to receive text, drawings, graphs, photographs or combinations of one or more of the above as comments.

In accordance with a fifth aspect of the invention there is a mobile device having a processor installed thereon, the processor comprising software instructions in the form of a software application, which, when accessed by a user, causes the mobile device to function as the first or second computing device.

In accordance with a sixth aspect of the invention there is a computer readable medium containing software instructions that when executed by a computer causes the computer to perform the method as set out in the third or fourth aspect of the invention.

### BRIEF DESCRIPTION OF THE DRAWINGS

The present invention will now be described, by way of example only, with reference to the accompanying drawings, in which:

FIG. 1 is the system architecture of an embodiment of the invention showing how the various parts of the system interact.

FIG. 2 is a flowchart of an embodiment of the invention showing how a user is taken through the system when the application is launched.

FIG. 3 is a state machine diagram of an embodiment of the invention.

FIG. 4 is a flowchart of an embodiment of the invention showing the verification process for the system.

FIG. 5 is a process flowchart showing the synchronization process of an embodiment of the invention.

Other arrangements of the invention are possible and, consequently, the accompanying drawing is not to be understood as superseding the generality of the preceding description of the invention.

### DETAILED DESCRIPTION

Particular embodiments of the present invention will now be described with reference to the accompanying drawings. The terminology used herein is for the purpose of describing particular embodiments only and is not intended to limit the scope of the present invention. Additionally, unless defined otherwise, all technical and scientific terms used herein have the same meanings as commonly understood by one of ordinary skill in the art to which this invention belongs.

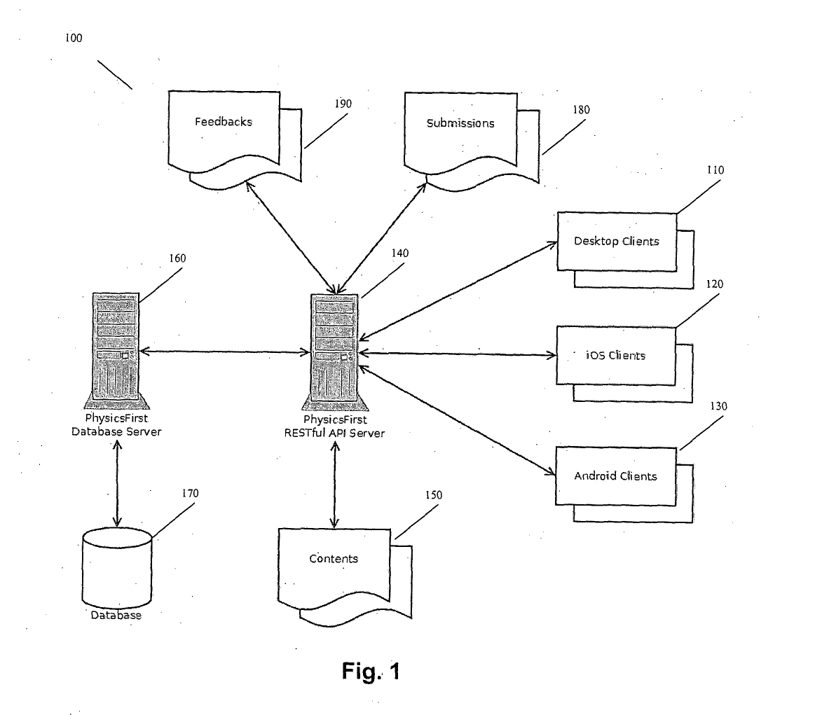

In accordance with an embodiment of the present invention there is a system 100 for managing interactive content. With further specific reference to FIG. 1 where the system operates in an e-learning environment context comprising a teacher and a plurality of students, the system comprises an application residing on a first computing device (used by a student) and second computing device (used by the teacher). The first and second computing devices may be a desktop client 110, iOS client 120, or Android client 130, which interacts with a server 140, in particular a web server 140. Further, the web server 140 may be a Representational State Transfer (termed ‘RESTful’) API server 140.

Installed on the first and second computing devices are software applications which are compatible with the API server 140. In the contact of the ‘RESTful’ API server, the software applications are APIs complying with the constraints of the same. The interaction between the software applications, colloquially referred to as ‘apps’ installed on the first computing device(s) 110, 120, 130 and the backend system will interact with RESTful APIs via the RESTful API server 140. The APIs are designed with standard RESTful interface vocabulary and the interaction data format will be JavaScript Object Notation (JSON). The interaction between the application and RESTful APIs are processing over the Hypertext Transfer Protocol (HTTP) with Secure Socket Layer (SSL). The domain certified SSL of the system can provide the maximum data security level with 256-bit encryption.

As an example of information flow in the API, to sign in to the system, it can be done via authentication, such as via a username and password which were created during account creation, which triggers a Login API from the application to the web server 140 (in this case the RESTful API server), which upon successful login returns an access token to the application, which in turn informs the user of a successful login. In this case and the following examples, the user is typically a student although a teacher can also access the same content as a student. Information can be requested by the user via the application to the webserver, which returns the user information and booklist, and the application presents this information. After a successful registration, the user can request a library list via the application, and the application presents the username and access token to the server, who retrieves the information from the database 170 via the database server 160 and returns this to the application, which is then checked and installed by the user.

The user can also request book lists via the application, which queries the server and obtains the book lists, and this information is updated in the user interface. The user can also request to download the book, and the application called Book API which transmits the username, access token and bookID to the server, which in turn retrieves the book contents from the database. The book contents can be compressed to save space using file formats such as zip file format. The book contents can then be saved by the application.

In the case of a new user, they can register via the application, and enter information like username, password and teacher's email for the application to send to the server. This is returned as user information and the application informs the user of a successful registration. For teachers, the registration may differ using an authentication method to confirm their identity. Alternatively, the registration of users for both teachers and students can be created and managed at the backend of the system, transparent to all users, who are then notified of their username and passwords separately.

In the case of an activity submission, the user can submit an activity via the application. This triggers a Submission API which submits the username, access token and activity data (for example in compressed format) to the server. The server would inform the application of a successful or failed submission and this is conveyed to the user for further action if needed. The user can also request for a list of activities submitted via the application, and this information is returned by the server and displayed by the application. The server thus keeps track of the submissions 180. The system also keeps track of the date and time of creating the submissions, together with the version, in the instance of resolving multiple submissions for an activity.

From a teacher's point of view, using the same application, a feedback list 190 can be requested and displayed via a Feedback API. The feedback is submitted by the user through the application which submits the username, access token and activity data to the server. The server would inform the application of a successful or failed submission and this is conveyed to the user for further action if needed. The user can also request for a list of activities submitted via the application, and this information is returned by the server and displayed by the application.

The system is not dependent solely on the three types of clients on which the application resides on as shown, and one skilled in the art would be able to ensure the system can be used on other types of clients as well.

In the system, interactive content is framed into a textbook or workbook for access on the PC and mobile devices that run iOS or Android operating systems. Elements of the content that requires an input (and submission for review) component from the part of the student will be synced from the client (eg. A student) through a central server to another client (eg. Teacher) and vice versa. When not syncing, the user can access the same ebook on the client (tablet or PC) with the latest-synced input.

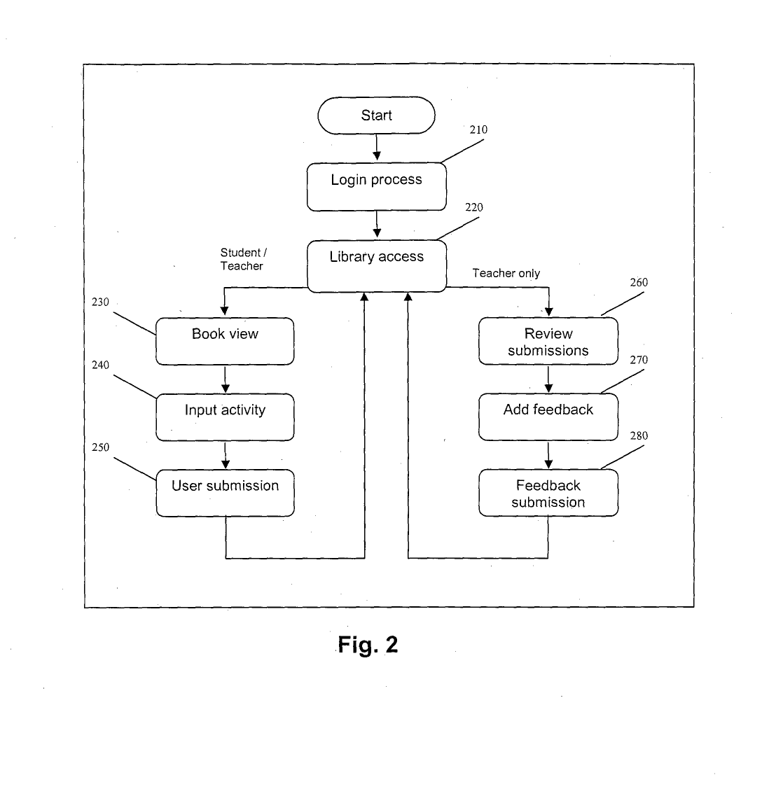

A flowchart shown in FIG. 2 describes an exemplary embodiment of how a user is taken through the system when the application is launched. During the Login process 210, the identity of the user is verified and the system also captures whether the type of account being access, which can be an administrative account, a student account or a teacher account. This Login process 210 can be done via a username and password, or using a security token plugged into the device running the application. At the server end, teacher and student accounts may be organized in groups for the purposes of interactions, so that a teacher can communicate directly with a specific group of student accounts for a particular subject (e.g. Physics).

Once logged in, the user is presented with a Library access 220 which shows a list of books that the user has presently subscribed to. The user can also manage the subscription via this screen and add books by searching for it via the online store via its name, ISBN number or any other unique identifier, and the book can be downloaded accordingly. Books can also be unsubscribed manually, or automatically after a time period has passed. Once downloaded, the book can be configured and used accordingly, for example the user can optionally set the name of the teacher for activity submission. Both teacher and student accounts can access the Book view 230, which allows them access to the book. The contents of the book can be searched using a search function and its results displayed in a panel alongside various other panels, including content panels that allows the user to navigate through the book quickly, for example by displaying chapter numbers and names, and allowing the user to jump to these sections by selecting them The contents panel may also allow the user to jump to the various activities to be completed for each section. The panel may also show a sounding board and a whiteboard, which allows for interactions to be made between users, for example teacher to students, or student to teacher. The sounding board is primarily a commenting function that may be linked to the material of the book being displayed and this can be moderated by the teacher. The whiteboard is a drawing board used by the teacher to explain concepts to the students, and can be done when the device screen is projected to the classroom.

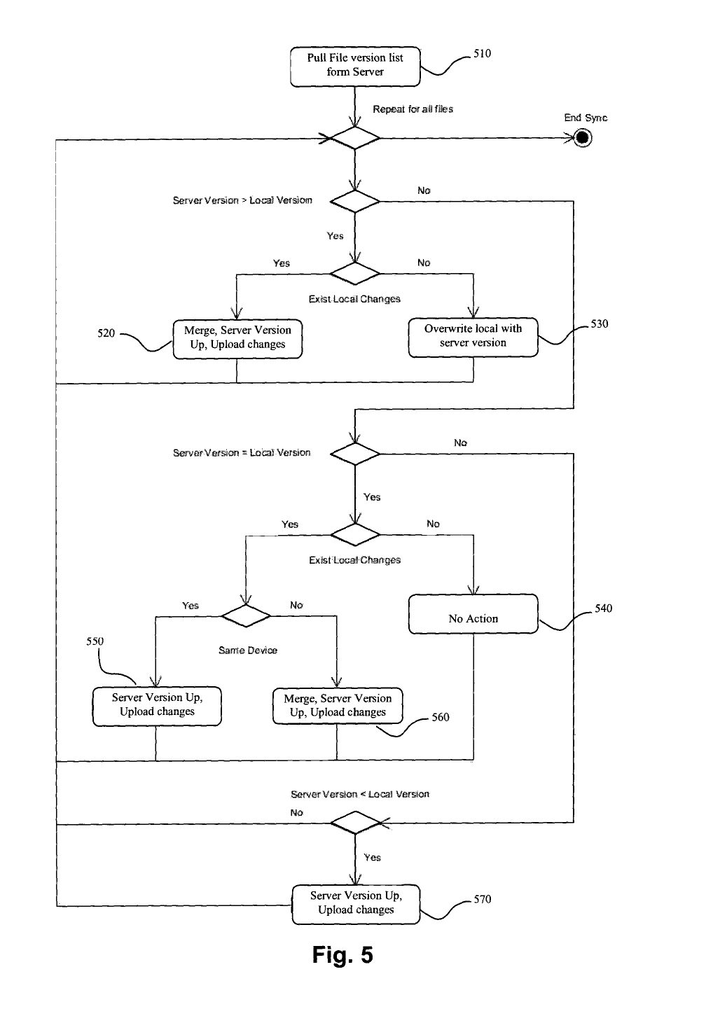

At the same time, various activities as shown in line with the contents of the book, and these are akin to boxes that a user can input into, the Input activity 240 step. Various questions or prompts can be displayed before each box and the inputs can take the form of text, drawings, graphs, or photographs, and a limit may be set on the amount of inputs to prevent memory overload. The boxes are dynamic and the application allows new boxes to be created alongside existing ones by shifting the contents of the book accordingly. This ensures that the inputs correspond with the activity that is designed for the content of book, for example corresponding with the chapter of material being taught. Although theoretically, an unlimited number of boxes can be created, for practical purposes and memory management, a limit on the number of boxes created per activity may be imposed. The user can be prompted, or manually choose to do so, to submit the input for an activity or multiple activities via the User submission 250, and once done the user returns to the Book view 230 or the Library access 220. The Book view 230 also allows for a calendar function that can also be displayed in a panel and can remind the user of any deadline for the completion of each activity, which can be set by a teacher account. Book view 230 also presents a sync option which allows the user to work offline and sync the book or activity with updates from the server as and when an internet connection is present. Alternatively, this sync option can be enabled or activated via User submission 250. As a user can submit at any time, and include multiple activities in each submission, there may be overlaps in the versions. The other scenario is when a user logs in using different devices and creates duplicate inputs without synching to the existing version. In this case, the system would prompt the user regarding the existence of multiple versions for an activity and if the user chooses so, merge the activities accordingly. Should more than one answer exist for an activity, the system would display both answers and save this accordingly. Alternatively, the system can also use the latest version and discard the earlier version accordingly, depending on the system or user preferences. This is further described in FIG. 5.

Each activity submitted would have a corresponding feedback box that a teacher can provide feedback with, and after the Login process 210, Library access 220 would present a teacher with the additional option of Review submissions 260, in which the teacher would be able to review all the submitted activities from the students and add feedback for each submission via Add feedback 270. The feedback can take the form of text, drawings, graphs, or photographs or a combination of these. The teacher would then have the option of adding more feedback for other students or activities, or hitting the submit button in Feedback submission 280 that would submit all the feedback created to the server and sent to the individual student's activity that corresponds accordingly. Notifications can be provided to the students to inform them that their activity has been reviewed with a corresponding feedback either via email, text message or when the student next logs in. When the student next accesses the application, the book view 230 then allows for the downloading of feedback to be viewed. The student then reviews the feedback, with the feedback box displayed immediately after the corresponding activity, and since the content of the book is dynamic, all the other contents of the book shifted to accommodate the feedback box accordingly, and the student can even add further inputs to the activity if required. Depending on the activity, the student may be allowed to submit again, thereby starting the feedback process by the teacher once more.

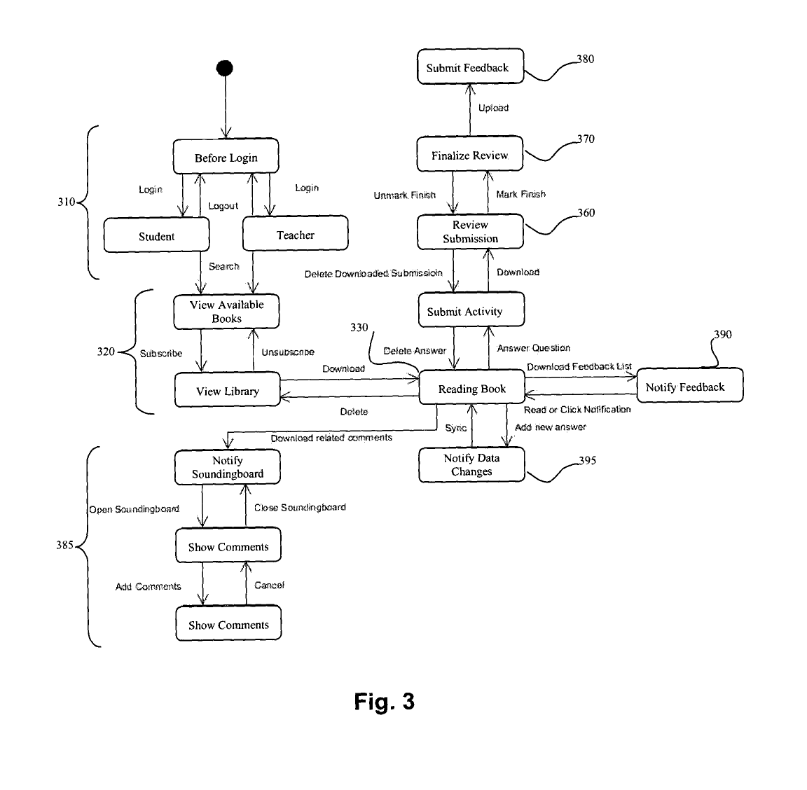

The state machine diagram for an embodiment of the invention is shown in FIG. 3 and shows the state of the application or computer program running within the system. There are corresponding states (using similar integer references) with the process flows described in relation to FIG. 2, for example the login process 310, the library access 320, and the book view 330. The activity can comprise of multiple answers, and each answer can be inputted in the form of text, drawings, graphs, or photographs or a combination of these. Each answer can also comprise of multiple inputs and the activity can be submitted 350, either automatically or manually at a later time if no internet connection were present at that moment. Thereafter each answer would have a corresponding feedback provided by the teacher after reviewing the submissions 360, adding and finalizing the reviews 370 before submitting the feedback 380. As mentioned previously, the student can be notified about the feedback 390 and the various activities and feedback can by synchronized 395 accordingly, either automatically or manually. The sounding board panel 385 is also shown to highlight how the commenting function would fit in with the rest of the system.

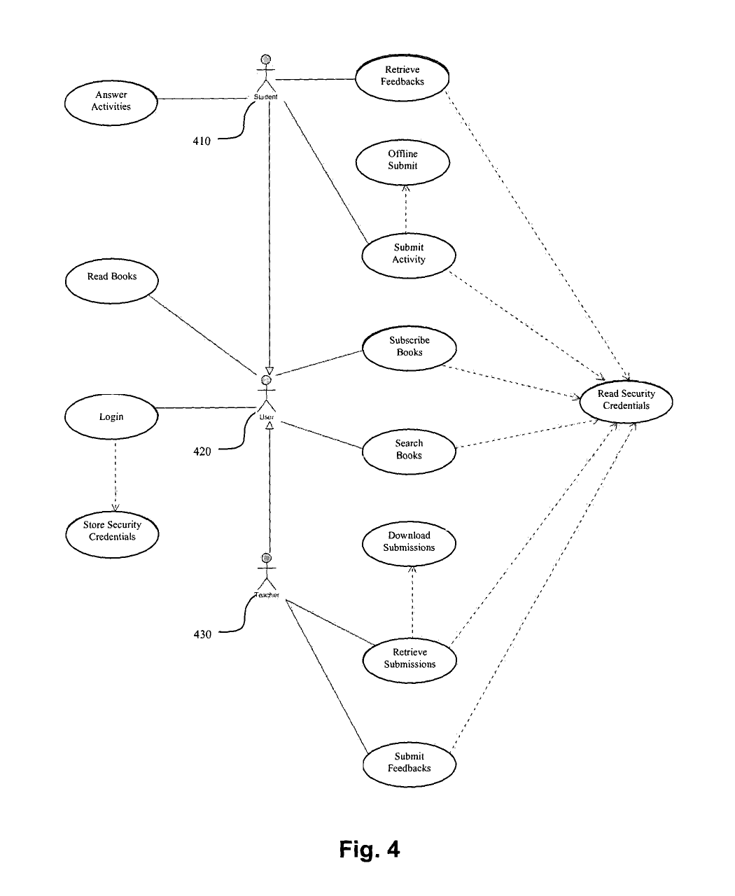

One example of the system shows the possible options for the users, including the verification process, in FIG. 4 and the description of the various conditions can correspond to the process flows in FIG. 2. The user can be a general user 420 with special permissions for students 410 to access certain material (and non-access to others); or a general user 420 with special permissions for teachers 430. For example, a general user 420 is able to read search, subscribe and read books, and if a general user 420 is able to login, the security credentials are stored accordingly. Similarly, a student 410 has similar rights with additional access to answer activities, submit the activities either online or offline, as well as retrieve feedbacks to the activities. A teacher 430 also has similar rights to the user with additional access to retrieve submissions (activities from students) by downloading them if required, as well as providing feedbacks to the activities. The system retrieves the security credentials as and when required based on the tasks chosen to ensure that the system is secure and the various users are accessing the correct content.

The synchronization process for the application is further elaborated in FIG. 5. In this embodiment, the system checks the activity and inputs and after retrieving the file version list from the server and database 510, the system checks whether there is a local version stored on the computing device, which may be a personal computer or a mobile device like a tablet or a mobile phone. In the case where the server version is newer than the local version, if there local changes have been made 520, the system merges both versions by displaying both versions with the server version being above the local version and uploads the merged version the server as an update to ensure that the merged version is used henceforth. If no local changes were made 530, the system overwrites the local version with the server version. There may be occasion where due to the preference of the user, the local version will always be overwritten by the server version. If both the server version and local version are essentially the same version, then the system checks, if no local changes have been made 540, no further action is taken. If local changes have been made, the system further checks whether it was made on the same device, if so, the server version has priority and the changes (local) are uploaded to the server 550. If it were not the same device, the system merges both versions by displaying both versions with the server version being above the local version and uploads the merged version as an update to ensure that the merged version is used henceforth 560 (similar to 520). Should the server version be older than the local version, the system uses the server version and uploads the changes 570 (similar to 550). Alternatively, instead of comparing date of the versions, the system can also use other criteria like comparing file sizes of the versions and allocating a higher priority to the larger of the two.

The portability of learning content means students and teachers can access the content anytime, anywhere on any mobile device, literally. This contrasts with online content that requires a stable internet connection and sizeable bandwidth for an acceptable consumption of the content. The system requires the internet only for synchronization and update purposes and not for content access.

This enables the teacher to elevate the quality and form of task to be given to the student as what was once mundane and flat homework can now be livened up with the integration of videos, audios and simulations that form the basis of each question the student needs to attempt as part of his homework. The system will also feature student input functionalities that were previously not possible, such as graphing analysis, mathematical function inputs etc.

These features have profound pedagogical significance as a teacher is now able to pose multi-modal challenges to students and demand an equally multi-modal response from them.

One possible scenario showcasing the invention is described below:

Device Distribution: 1-to-1 Computing
with each student having the same device, OR
in a bring-your-own device environment, where each student brings a different device (e.g., Laptop, Android-based phone or iPhone, iPad or Android tablet)

### During the Lesson:

The teacher will project his copy of the system on screen or an interactive whiteboard and use the various interactive elements in the system to deliver the lesson. At times, the teacher may invite students to work on some exercises in their own devices and take turns to come forward and show the rest of the class their solutions for discussion.
Towards the end of the lesson, the teacher tasks the students to work on some exercises as homework, reminding them to save their answers and connect their devices to the internet at the end of each night if they have not already done so.

### After the Lesson:

Two students decided to work on their homework after school on the way home in the train or bus:
Student A starts working on the homework via the iPad. As Student A's iPad does not have a mobile dataplan, any input from her will be stored in the iPad, until she gets home and hook up to the wireless network at home. At that time, all inputs from her will be synchronized to the Cloud.
Student B does the same on his Samsung Galaxy SIII but since his smartphone comes with a mobile dataplan, any input from him is automatically synchronized to the Cloud.

The questions that both students worked on are quite varied, ranging from them having to input a mathematical formula to digitally plotting a graph and even taking a photograph and uploading it as part of the answer to some questions.

Once home, both Students A and B continued their homework on the PC, which displays the latest copy of the eBook synchronized from the Cloud.

At the same time, both students noticed that their teacher had added some comments on the previous homework task that they submitted and decided to review those pages of the previous homework and study the teacher's comments.
Teacher: While on the train to meet someone after school, the teacher decided to review the students' work in the previous assignment, using her iPad Mini that does not have a mobile dataplan. However, since she last synced her eBook on the school's wireless network, right before she left the school, the collection of students' ebooks on her iPad Mini should be relatively up to date. She could see that most students have submitted some inputs on their assignment, except for two students, whom she made a mental note to follow-up with the next day.

As the teacher reviews each question from Student A, she decided to add comments to each answer input from Student A by activating the ‘add comment’ function. In some instances, she would ‘layer her answer’ over Student A's, for example, by plotting the correct curve on the graph space provided.

Once she has finished reviewing a question, she decides if she wishes to just save her comments or save and upload her comments at the next available opportunity when an internet connection is available. This feedback function allows the teacher to provide feedback on the answers received to the student, and the student is notified at the next log in that feedback was received in relation to the answers submitted. The student can then further amend the answer if required and submit accordingly, thereby starting the process again.

During her meeting, the teacher noted that free wireless network is available and hooks her iPad Mini up to a wireless network. Any input from her would be uploaded to the Cloud and the latest input from her students from the Cloud to her iPad Mini.

When both student and teacher return to the classroom for the next lesson, the teacher may project any of her students' work on screen to discuss some of the answers with the rest of the class.

The features of the proposed system enable teachers to augment and modify their workflow in the following ways:
The teacher no longer needs to physically collect the workbooks and deprive her students of their learning material. She simply opens her own version of the workbook and the students' books will be available for her to open and review at will.
The workflow on the part of the teacher hasn't changed significantly, making a possible adoption a lot easier.
The system is simple to use and teacher-friendly, minimizing the need for the teacher to learn how to use the system.
The system does not require a complex internet-based setup during lessons, removing the possibility of technical challenges that threaten to derail or delay each lesson.
The system enables the teacher to review and assess students' work anytime, anywhere, independent of the mobile device and the presence of an internet connection.

In the current system of using printed worksheets, the teacher takes roughly 1 week (7 days) to turn around a set of worksheets submitted by her students. In some cases where the teacher may be overwhelmed by work for various reasons, the students may be deprived of the worksheet for more than 6 weeks. This drastically reduces the learning productivity of students.

Having a system that does not remove the learning material from the student due to an unstable internet connection or the teacher's need to review the student's input means that the student will always have access to the learning resource—this is a unique proposition of the system.

Having rich-media content as part of the learning resource is an important requirement to promote inquiry-based learning in students today. Interviews and field research conducted with teachers in local schools have found that such content, when implemented with fidelity, can raise the productivity of learning by up to 200%, with students taking half the time to understand key concepts as compared to when they were taught using the current methods of instruction.

Currently, the most widely-used worksheets still exist in printed form. These may either be produced by the teachers themselves or procured from publishers of approved printed textbooks and workbooks.

To manage the potential decrease in learning productivity that results from the collection of workbooks from the students for review purposes, some publishers have taken the initiative to create workbooks with perforated worksheets that allow for the students to detach individual worksheets from the workbooks and submit to the teacher for review. While commendable, this method has resulted in two additional burdens on the part of students and their teachers:
a. Increase in the cost of workbooks, since they now cost more to print and bind.
b. Created a need to have students properly file their worksheets and have their files checked regularly by the teacher to ensure that all is in order. This significantly reduces the productivity of teachers.

The deployment of the system relieves teachers and students of these burdens. Its internet independency with background data syncing capability also means that access to learning content is no longer at the mercy of a stable internet connection, unlike content offerings made available through internet-dependent systems such as the web browser and the LMS.

The above is a description of one embodiment of a system for managing a workbook in a learning environment. It is envisioned that those skilled in the art can and will design an alternative embodiment of this invention that falls within the scope of the invention. In particular, it is to be appreciated that features from various embodiment(s) may be combined to form one or more additional embodiments.

1. A system for managing interactive content comprising
a first computing device configured to receive interactive content comprising at least one activity, the at least one activity requires the submission of an input of a first user;
a second computing device configured to allow a second user to submit a comment on the input of the first user; and
a server arranged to receive the input or comment of either the first or second computing device where a data connection is present;
wherein the first and second computing devices are configured to detect the presence of data connection with the server and upon detection of the presence of data connection with the server; prompt the first or second user to synchronize:
i. any activity within the interactive content on the server that the first and second computing devices have permission to access respectively; and
ii. any activity within the interactive content input or comment by the first or second user respectively,
wherein the input of the first user is added to the activity of the interactive content and the interactive content is an electronic book.

2. A system for managing interactive content comprising
a first computing device configured to receive interactive content comprising at least one activity, the at least one activity requires the submission of an input of a first user;
a second computing device configured to allow a second user to submit a comment on the input of the first user ; and
a server arranged to receive the input or comment of either the first or second computing device where a data connection is present;
wherein the server is configured to detect the presence of data connection with the first or second computing device and upon detection of the presence of data connection with the first or second computing device, synchronize
i. any activity within the interactive content on the server that the first or second computing devices have permission to access respectively and;
ii. any activity within the interactive content input or comment by the first or second user respectively,
wherein the input of the first user is added to the activity of the interactive content and the interactive content is an electronic book.

3. A system according to claim 1 or 2, wherein the comment of the second user is added to the activity where the input of the first user was added to the interactive content.

4. A system according to claim 1 or 2, wherein the system is a learning management system and the first user is a student and the second user is a teacher or instructor.

5. A system according to claim 3, wherein the activity is dynamically embedded in the electronic book.

6. A system according to claim 1 or 2, further comprising a secure token operable to be used by the first user or the second user to register with the server.

7. A system according to claim 6 wherein the registration further comprises security verification via a unique identifier and password for the first and second user.

8. A system according to claim 1 or 2, wherein the server sends a notification to the first computing device when comment to the at least one activity is received by the server.

9. A system according to claim 8, wherein the first computing device is operable to receive a further input from the first user in response to the comment to the at least one activity.

10. A system according to claim 1 or 2, wherein the server merges multiple versions of the inputs when the first user submits multiple versions of the inputs by using all versions of the inputs in relation to the activity.

11. A system according to claim 1 or 2, wherein the server merges multiple versions of the inputs when the first user submits multiple versions of the input by the first user by discarding an earlier version of the input.

12. A system according to claim 1 or 2, wherein the server merges multiple versions of the inputs when the first user submits multiple versions of the input by discarding the version of the same input with a smaller file size.

13. A system according to claim 1 or 2, wherein the second computing device is configured to receive a score which accompanies the comment by the second user.

14. A system according to claim 1 or 2, wherein the server is operable, when a data connection is present, to receive instruction from the second computing device to combine one or more interactive content on the server.

15. A system according to claim 1 or 2, wherein the first computing device is configured to receive text, drawings, graphs, photographs or combinations of one or more of the above as inputs.

16. A system according to claim 1 or 2, wherein the second computing device is configured to receive text, drawings, graphs, photographs or combinations of one or more of the above as comments.

17. A method for managing interactive content comprising the following steps:
receiving at a first computing device interactive content comprising at least one activity, the at least one activity requiring the submission of an input of a first user;
submitting to a server at least one activity with the input of the first user;
receiving at a second computing device at least one activity with the input of the first user;
creating a comment by a second user in response to the at least one activity, and submitting to the server at least one activity with the comment by the second user;
wherein the server is arranged to receive the input or comment of either the first or second computing device when a data connection is present, the first and second computing devices further configured to detect the presence of data connection with the server and upon detection of the presence of data connection with the server; prompt the first or second user to synchronize
i. any activity within the interactive content on the server that the first and second computing devices have permission to access respectively and
ii. any activity within the interactive content input or commented by the first or second user respectively,
wherein the input of the first user is added to the activity of the interactive content and the interactive content is an electronic book.

18. A method for managing interactive content comprising the following steps:
receiving at a first computing device interactive content comprising at least one activity, the at least one activity requiring the input of a first user;
submitting to a server (receiving at a server) at least one activity with the input of the first user;
receiving at a second computing device at least one activity with the input of the first user;
creating a comment by a second user in response to the at least one activity; and
submitting to the server at least one activity with the comment by the second user;
wherein the server is configured to detect the presence of data connection with the first or second computing device and upon detection of the presence of data connection with the first or second computing device, synchronize
i. any activity within the interactive content on the server that the first or second computing devices have permission to access respectively and;
ii. any activity within the interactive content input or comment by the first or second user respectively,
wherein the input of the first user is added to the activity of the interactive content and the interactive content is an electronic book.

19. A method according to claim 17 or 18, wherein the comment of the second user is added to the activity where the input of the first user was added to the interactive content.

20. A method according to claim 17 or 18, wherein the method is adapted for use in a learning management system where the first user is a student and the second user is a teacher or instructor.

21. A method according to claim 19, wherein the activity is dynamically embedded in the electronic book.

22. A method according to claim 17 or 18, further comprising a step to authenticate the first user or the second user for access to the interactive content or uploading any input/commented activity.

23. A method according to claim 22, wherein the step to authenticate further comprises security verification via a unique identifier and password for the first and second user.

24. A method according to claim 17 or 18, wherein the server sends a notification to the first computing device when comment to the at least one activity is received by the server.

25. A method according to claim 24, wherein the first computing device receives a further input from the first user in response to the comment to the at least one activity.

26. A method according to claim 17 or 18, wherein the server is arranged to merge multiple versions of the inputs when the first user submits multiple versions of the input by using all versions of the inputs in relation to the activity.

27. A method according to claim 17 or 18, wherein the server merges multiple versions of the inputs when the first user submits multiple versions of the input by the first user by discarding an earlier version of the input.

28. A method according to claim 17 or 18, wherein the server merges multiple versions of the inputs when the first user submits multiple versions of the input by discarding the version of the same input with a smaller file size.

29. A method according to claim 17 or 18, wherein the second computing device is configured to receive a score which accompanies the comment by the second user.

30. A method according to claim 17 or 18, wherein the server is operable, when a data connection is present, to receive instruction from the second computing device to combine one or more interactive content on the server.

31. A method according to claim 17 or 18, wherein the first computing device is configured to receive text, drawings, graphs, photographs or combinations of one or more of the above as inputs.

32. A method according to claim 17 or 18, wherein the second computing device is configured to receive text, drawings, graphs, photographs or combinations of one or more of the above as comments.

33. A mobile device having a processor installed thereon, the processor comprising software instructions in the form of a software application, which, when accessed by a user, causes the mobile device to function as the first or second computing device of any one of claims 1, 2, 17 or 18.

34. A computer readable medium containing software instructions that when executed by a computer causes the computer to perform the method as claimed in claim 17 or 18.
